(19) United States
(12) Patent Application Publication
(10) Pub. No.: US 2007/0089097 A1
(43) Pub. Date: Apr. 19, 2007

(54) Region based code straightening

(76) Inventors: Liangxiao Hu, North York (CA); Mark Peter Mendell, Toronto (CA); Raul Esteban Silvera, Woodbridge (CA)

Correspondence Address: IBM CORP (YA);C/O YEE & ASSOCIATES PC, P.O. BOX 802333, DALLAS, TX, 75380, US

(21) Appl. No.: 11/250,009

(22) Filed: Oct. 13, 2005

(51) Int. Cl. G06F 9/44

(52) U.S. Cl. 717/132

(57) ABSTRACT

An optimization mechanism in a compiler performs region-based code straightening to line up frequently executed basic blocks together based on profile directed feedback. The region-based code straightening lines up the basic blocks in order of execution sequence, but does not move infrequently executed basic blocks too far away from predecessors. As such, code locality is maintained, thus reducing instruction cache misses.

### BACKGROUND OF THE INVENTION

1. Field of the Invention

The present invention relates generally to data processing and, in particular, to compiling computer instructions in a data processing system. Still more particularly, the present invention relates to optimizing application code to line up frequent blocks based on profile directed feedback while maintaining code locality.

2. Description of the Related Art

When an application is compiled, the instructions may be divided into basic blocks. A basic block is a series of instructions that ends with a conditional branch or an unconditional branch. Because a basic block ends in a branch, the series of instructions within the block executes successively. At the end of a basic block, execution may transfer to the very first instruction of the same basic block, transfer to an earlier basic block, or proceed to a succeeding basic block.

When the compiled code is executed, one or more basic blocks may be fetched into instruction cache to improve runtime performance. Code straightening or code positioning is a compiler optimization technique for reordering the position of the procedures inside a program or the position of the basic blocks inside a procedure to reduce cache miss ratio of the instruction cache and to better utilize hardware branch prediction mechanisms of modern processors, thus improving the runtime performance of the program or application code.

Known code straightening methods reorder basic blocks solely based on execution frequency. These known methods place the most frequently executed blocks together to avoid cache misses. Often, infrequent blocks are placed at the end of the critical path. Also, an important drawback of some known methods is that even the critical path may not be ordered by execution order. For example, a successor of a block may be placed before the block itself.

### SUMMARY OF THE INVENTION

The present invention recognizes the disadvantages of the prior art and provides a region-based method for optimizing application code. A compiler creates a control flow graph for a procedure. The control flow graph represents the procedure and flow of control between instruction blocks of the procedure and wherein the control flow graph includes profile information for the instruction blocks. A region based code straightening mechanism in the compiler performs a depth-first search of the control flow graph to form an ordered list of instruction blocks. The region based code straightening mechanism moves at least one instruction block closer to its predecessor, wherein the region based code straightening generates a final list of instruction blocks.

### BRIEF DESCRIPTION OF THE DRAWINGS

The novel features of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a data processing system in which the present invention may be implemented in accordance with exemplary aspects of the present invention;

FIG. 2 is a block diagram of a data processing system in which exemplary aspects of the present invention may be implemented;

FIG. 3 illustrates an example of a control flow graph in accordance with exemplary aspects of the present invention;

FIG. 4 illustrates an example basic block list that results from a depth-first search in accordance with exemplary aspects of the present invention;

FIG. 5A illustrates an example basic block list after code straightening in accordance with exemplary aspects of the present invention;

FIG. 5B depicts an example final block list with a small instruction cache relative to the size of a basic block in accordance with exemplary aspects of the present invention;

FIG. 6 illustrates a new control flow graph after code straightening in accordance with exemplary aspects of the present invention;

FIG. 7 is a block diagram depicting a compiler configuration in accordance with exemplary aspects of the present invention;

FIG. 8 is a flowchart illustrating operation of a compiler with a region based code straightening mechanism in accordance with an exemplary embodiment of the present invention; and

FIG. 9 is a flowchart illustrating operation of a region based code straightening mechanism in accordance with an exemplary embodiment of the present invention.

### DETAILED DESCRIPTION OF THE PREFERRED EMBODIMENT

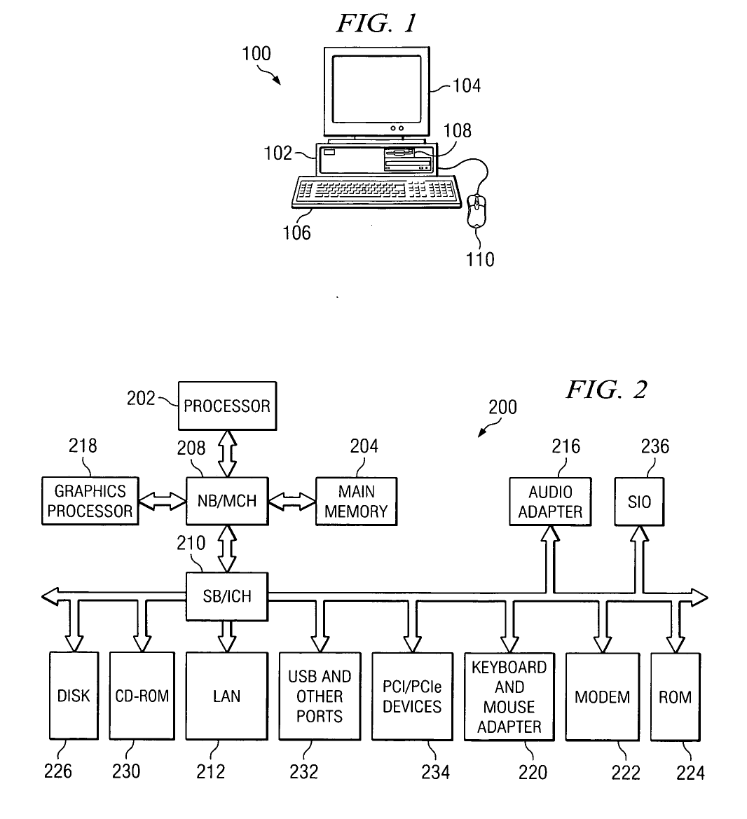

FIGS. 1-2 are provided as diagrams of exemplary data processing environments in which embodiments of the present invention may be implemented. It should be appreciated that FIGS. 1-2 are only exemplary and are not intended to assert or imply any limitation with regard to the environments in which aspects or embodiments of the present invention may be implemented. Many modifications to the depicted environments may be made without departing from the spirit and scope of the present invention.

With reference now to the figures and in particular with reference to FIG. 1, a pictorial representation of a data processing system in which the present invention may be implemented is depicted in accordance with exemplary aspects of the present invention. A computer 100 is depicted which includes system unit 102, video display terminal 104, keyboard 106, storage devices 108, which may include floppy drives and other types of permanent and removable storage media, and mouse 110. Additional input devices may be included with personal computer 100, such as, for example, a joystick, touchpad, touch screen, trackball, microphone, and the like.

Computer 100 can be implemented using any suitable computer, such as an IBM eServer™ computer or IntelliStation® computer, which are products of International Business Machines Corporation, located in Armonk, N.Y. Although the depicted representation shows a computer, other embodiments of the present invention may be implemented in other types of data processing systems, such as a network computer. Computer 100 also preferably includes a graphical user interface (GUI) that may be implemented by means of systems software residing in computer readable media in operation within computer 100.

With reference now to FIG. 2, a block diagram of a data processing system is shown in which exemplary aspects of the present invention may be implemented. Data processing system 200 is an example of a computer, such as computer 100 in FIG. 1, in which code or instructions implementing the processes of the present invention may be located. In the depicted example, data processing system 200 employs a hub architecture including a north bridge and memory controller hub (MCH) 208 and a south bridge and input/output (I/O) controller hub (ICH) 210. Processor 202, main memory 204, and graphics processor 218 are connected to MCH 208. Graphics processor 218 may be connected to the MCH through an accelerated graphics port (AGP), for example.

In the depicted example, local area network (LAN) adapter 212, audio adapter 216, keyboard and mouse adapter 220, modem 222, read only memory (ROM) 224, hard disk drive (HDD) 226, CD-ROM driver 230, universal serial bus (USB) ports and other communications ports 232, and PCI/PCIe devices 234 may be connected to ICH 210. PCI/PCIe devices may include, for example, Ethernet adapters, add-in cards, PC cards for notebook computers, etc. PCI uses a cardbus controller, while PCIe does not. ROM 224 may be, for example, a flash binary input/output system (BIOS). Hard disk drive 226 and CD-ROM drive 230 may use, for example, an integrated drive electronics (IDE) or serial advanced technology attachment (SATA) interface. A super I/O (SIO) device 236 may be connected to ICH 210.

An operating system runs on processor 202 and is used to coordinate and provide control of various components within data processing system 200 in FIG. 2. The operating system may be a commercially available operating system such as Windows XP™, which is available from Microsoft Corporation. An object oriented programming system, such as Java™ programming system, may run in conjunction with the operating system and provides calls to the operating system from Java programs or applications executing on data processing system 200. “JAVA” is a trademark of Sun Microsystems, Inc. Instructions for the operating system, the object-oriented programming system, and applications or programs are located on storage devices, such as hard disk drive 226, and may be loaded into main memory 204 for execution by processor 202. The processes of the present invention are performed by processor 202 using computer implemented instructions, which may be located in a memory such as, for example, main memory 204, ROM 224, or in one or more peripheral devices 226 and 230.

In accordance with exemplary aspects of the present invention, a compiler converts source code into machine instructions for execution on a computer, such as data processing system 200. In general, the compiler can do many transformations (or optimizations) based on user specified optimization level to reduce the code size and to generate better code for application program. Usually, the generated code can be executed much faster than the code without such transformation. One of the transformations may be code straightening. Code straightening reorders the position of the procedures inside a program or the position of the basic blocks inside a procedure to improve the performance of the application code by reducing the instruction cache miss ratio and better utilizing the hardware instruction fetch mechanism and branch prediction mechanisms of modern processors. According to an exemplary embodiment of the present invention, the compiler performs code straightening based on profile directed feedback to line up most frequently executed instructions together while maintaining code locality.

Those of ordinary skill in the art will appreciate that the hardware in FIG. 2 may vary depending on the implementation. Other internal hardware or peripheral devices, such as flash memory, equivalent non-volatile memory, or optical disk drives and the like, may be used in addition to or in place of the hardware depicted in FIG. 2. Also, the processes of the present invention may be applied to a multiprocessor data processing system. The depicted example in FIG. 2 and above-described examples are not meant to imply architectural limitations.

As stated above, in accordance with exemplary aspects of the present invention, a compiler performs region-based code straightening to line up frequently executed basic blocks together based on profile directed feedback. The region-based code straightening lines up the basic blocks in order of execution sequence, but does not move infrequently executed basic blocks too far away from predecessors. As such, code locality is maintained, thus reducing instruction cache misses.

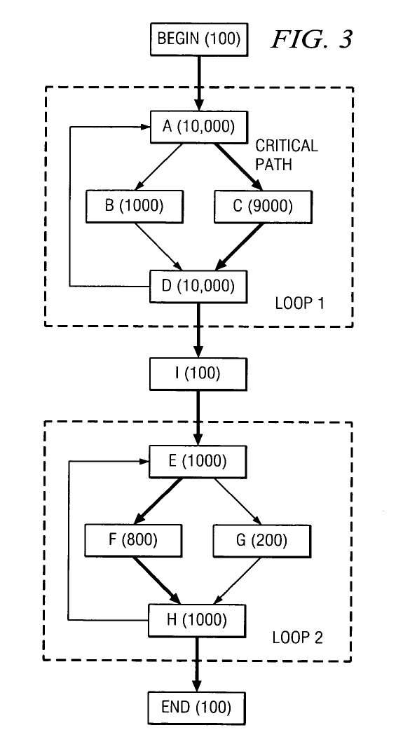

A system for optimizing an application includes a compiler. A compiler does a lot of optimizations and it transforms high-level user programs into machine instructions. A compiler builds control flow graph for each procedure in the application code. FIG. 3 illustrates an example of a control flow graph in accordance with exemplary aspects of the present invention. A control flow graph is a representation of a procedure being compiled that shows the flow of control between basic blocks of the procedure. A sequence of instructions in which flow of control can only enter at the very first instruction and exit only at the very end of the sequence is abstracted as a basic block. The basic block is executed from start to end without halt or possibility of branching except at the very end.

The control flow graph is constructed by examining the instructions of a procedure and creating a node for each basic block and adding edges between the nodes to represent flow of control transfers introduced by branch instructions. The compiler may instrument a procedure by providing counters that count the number of times each basic block is executed. This information would be gathered in the first pass of compilation. The information contained by the counters is referred to as profile directed feedback or profile information.

The profile information can be used by the compiler by compiling the application code twice. At the first pass compilation, the compiler inserts some instrumentation code to the application code, generates the instrumented version of the application code. Then, a user or compiler (for a dynamic compiler like a just in time (JIT) compiler) runs the instrumented version of application code with some training data (some small input data that represents a typical work load of the application). The instrumented code generates the profile information and stores the profile information somewhere (e.g., in a file). Thereafter, at the second pass compilation, the compiler makes use of the generated profile information to guide other optimizations. The region based code straightening of the present invention also requires the profile information.

More particularly, at the second pass compilation, the code straightening mechanism of the compiler reorders or repositions those basic blocks according to the execution frequency and execution sequence. The code straightening mechanism of the compiler first performs a depth-first search of the control flow graph. The search starts from the entry of the control flow graph, block Begin in the example of FIG. 3. If a block only has one successor, the code straightening mechanism visits the successor first in a recursive depth-first search fashion after block A is visited. A successor is a block that is executed after a current block.

If a block has multiple successors, such as when a block ends in a conditional branch, like block A in FIG. 3, the code straightening mechanism visits its most likely successor first after that block is visited, again in depth-first search fashion. A successor is a most likely successor if it will be executed at higher probability than its other siblings when block A is executed. A determination of which successor, or sibling, is most likely is made based on branch taken/non-taken percentage or edge count which can be calculated from profile information as shown in FIG. 3. In the example shown in FIG. 3, block A has two potential successors, block B and block C. In this instance, block C has a higher frequency (executed 9000 times) than block B (executed 1000 times), so 90% of the time, block C will be executed after A, 10% of the time, block B will be executed after A; therefore, block C is the more likely successor of block A. Thus, the next step of the depth-first search is to visit block C.

In the example shown in FIG. 3, block C has one successor, block D. Then, block D has two successors, block A and block I, the more likely of which is block A, but block A is already visited, so the method will visit I after D. Block I has one successor, which is block E.

The depth-first search generates a list. All the frequently executed blocks are lined up according to execution sequence. This is referred to as the critical path. All the infrequently executed blocks are moved to the position after the critical path.

As shown in FIG. 3, the control flow graph contains two loops. Loop 1 contains block A, block B, block C, and block D. Loop 2 contains block E, block F, block G, and block H. Among those basic blocks, block A, block D, block E, and block H end with conditional branches. Block C is more frequently executed than block B. Block F is more frequently executed than block G. Also, in this example, the frequency of block B is much higher than block I.

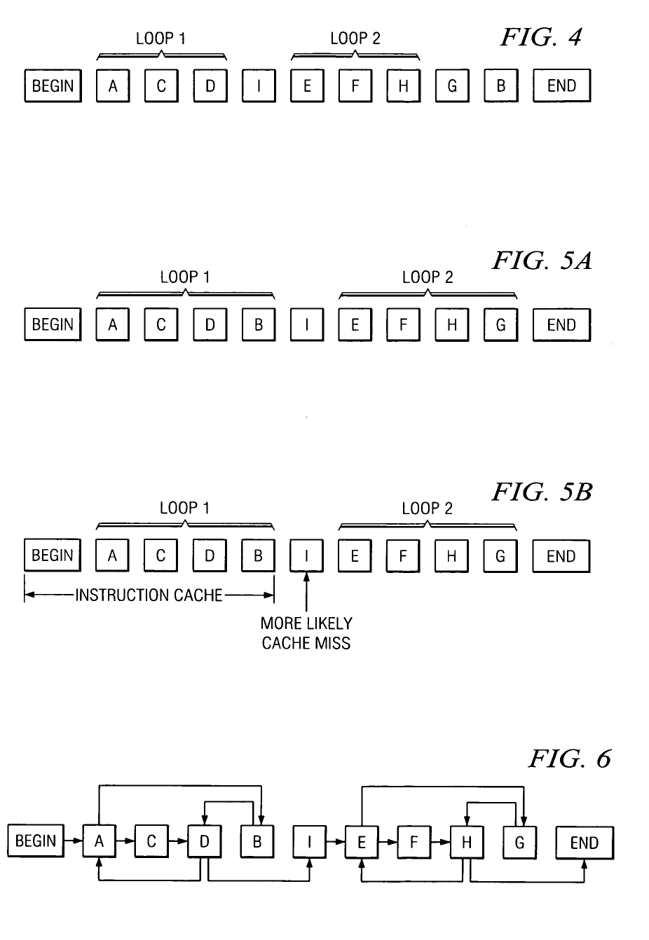

FIG. 4 illustrates an example basic block list that results from a depth-first search in accordance with exemplary aspects of the present invention. Note that block B is moved to the position after loop 2. However, logically, block B will be executed before block I and loop 2. If there are some other basic blocks between loop 1 and loop 2 or the code in block I is big enough such that the distance between loop 1 and loop 2 is considerable, placing block B after loop 2 could introduce some instruction cache misses.

In accordance with exemplary aspects of the present invention, the code straightening mechanism then generates a final list based on the depth-first list. A block is appended to the final list if the immediate containing region of the block to be appended is the same immediate containing region as the previous block. A region is the context of a loop. Loops may be nested; therefore, a region may have a sub-region. If a block is not in the same immediate region as a preceding block, the block may be in the same region on a higher level.

If the last appended block in the final list ends a region and the next block N in the depth-first list starts a new region, and the new region is not contained by the region of last appended block, then any infrequently executed blocks that are contained by the previous region are inserted at this point under certain circumstances (e.g.: if the infrequently executed block is more frequently executed than block N). For instance, the code straightening mechanism may determine whether the profile directed feedback block counter of the infrequently executed block is greater than the counter of block N by a predetermined threshold or a predetermined factor. For instance, the infrequently executed block may be placed before block N if the infrequently executed block executes twice as frequently as block N.

All predecessors of the concerned infrequently executed block may also be placed before the successor. The blocks will be inserted in the order of predecessor comes before successor whenever possible. This preserves locality with respect to the infrequently executed block and reduces the likelihood of cache misses by keeping the order of instructions in consideration.

FIG. 5A illustrates an example basic block list after code straightening in accordance with exemplary aspects of the present invention. Notice that block B is placed closer to the other blocks of loop 1, which may reduce the possibility of instruction cache misses. FIG. 5B depicts an example final block list with a small instruction cache compared to the size of a basic block in accordance with exemplary aspects of the present invention. If the instruction cache fetches block Begin, block A, block C, block D, and block B, then in the actual case where block B executes after block A at runtime, block B will not result in a cache miss. Even though the execution of block B may be infrequent compared to the frequency of execution of block C, block B will still be executed before block I and block E. Furthermore, as discussed above, the execution frequency of block B is much higher than block I.

The code straightening mechanism then uses the final list to change the layout of the control flow graph. The code straightening mechanism inserts unconditional branches wherever necessary. For example, if the only successor of a block is not the next block in the control flow graph, or the flow through block of a block ended with a conditional branch is not the next block in the control flow graph, an unconditional branch will be inserted. In the example shown in FIG. 3, there may be an unconditional branch at the end of block B and block G, for instance.

The examples shown in FIGS. 3, 4, 5A, and 5B may be relatively simple compared to an actual application. Block I is an abstracted basic block. In actuality, block I could contain many basic blocks and loops. Still further, a typical application may also have many more basic blocks, nested loops, conditional branches with more than two possible successors, and so forth.

FIG. 6 illustrates a new control flow graph after code straightening in accordance with exemplary aspects of the present invention. In the new control flow graph, the critical path of a region is lined up together in the order of execution sequence. The conditional branch at the end of a region is more frequently taken backward, thus executing instructions that may already be in the instruction cache. The infrequent path of a region is moved to be closer to its region so code locality is maintained, which in turn should reduce instruction cache misses. Therefore, execution of code according to the control flow graph in FIG. 6, for example, will likely have better performance.

More particularly, in FIG. 6, block C becomes the fall-through block of the conditional branch in A and block F becomes the fall-through block of the conditional branch in E, which will benefit most of the modern processors. Even though the code straightening technique has the side effect of introducing two more new unconditional branches, the benefit usually outweighs the drawback.

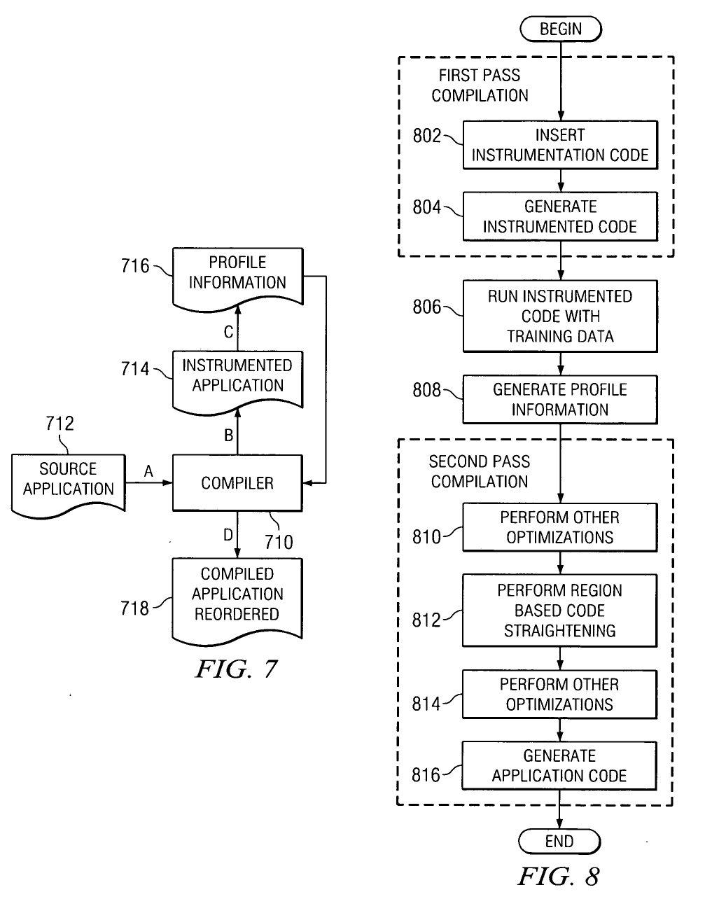

FIG. 7 is a block diagram depicting a compiler configuration in accordance with exemplary aspects of the present invention. Compiler 710 converts source application 712 into machine code that is optimized to execute on a particular processor architecture. Source application 712 may be some application or procedure in a high level source language, such as C++, for example. In step A, compiler 710 receives source application 712. Compiler 710 compiles the application and inserts instrumentation code in step B (first pass compilation) to form instrumented application code 714.

In step C, a user or compiler runs instrumented application 714 with some training data to generate profile information 716. Thereafter, in step D, compiler 710 takes profile information 716 as an additional input and recompiles source application 712 (second pass compilation). During the second pass compilation, compiler 710 may perform additional optimizations, as well as region based code straightening. Compiler 710 generates compiled application 718, which is reordered to maintain locality and, thus, reduce instruction cache misses.

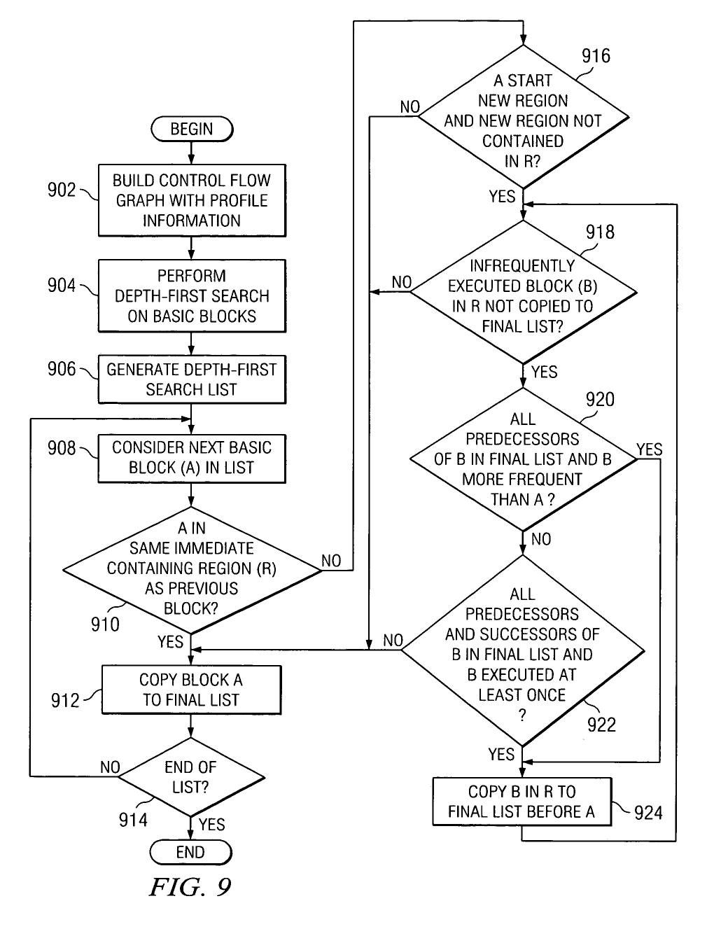

FIG. 8 is a flowchart illustrating operation of a compiler with a code straightening mechanism in accordance with an exemplary embodiment of the present invention. Note that FIG. 8 shall not be limited to the operation of a dynamic compiler, in which the compiler itself runs the instrumented version of application code. Rather, in the case of a static compiler, a user may invoke the compiler twice to run the instrumented code. Thus, some steps of FIG. 8 may be invoked by a user rather than the compiler itself. FIG. 9 is a flowchart illustrating operation of a region based code straightening mechanism in accordance with an exemplary embodiment of the present invention.

It will be understood that each block of the flowchart illustrations, and combinations of blocks in the flowchart illustrations, can be implemented by computer program instructions. These computer program instructions may be provided to a processor or other programmable data processing apparatus to produce a machine, such that the instructions which execute on the processor or other programmable data processing apparatus create means for implementing the functions specified in the flowchart block or blocks. These computer program instructions may also be stored in a computer-readable memory or storage medium that can direct a processor or other programmable data processing apparatus to function in a particular manner, such that the instructions stored in the computer-readable memory or storage medium produce an article of manufacture including instruction means which implement the functions specified in the flowchart block or blocks.

Accordingly, blocks of the flowchart illustrations support combinations of means for performing the specified functions, combinations of steps for performing the specified functions and computer usable program code for performing the specified functions. It will also be understood that each block of the flowchart illustrations, and combinations of blocks in the flowchart illustrations, can be implemented by special purpose hardware-based computer systems which perform the specified functions or steps, or by combinations of special purpose hardware and computer instructions.

With particular reference to FIG. 8, operation of a compiler with region based code straightening is illustrated. In a compiler that supports optimization based on profile information (or profile directed feedback), the compiler usually compiles application code twice. A two-pass compilation could either be invoked by a user or by the compiler itself, depending on whether the compiler is a static or dynamic compiler.

During first pass compilation, the compiler compiles the application and inserts instrumentation code into the compiled application (block 802) and generates instrumented application code (block 804). Then, the compiler or user runs the instrumented application with some training data (block 806). The instrumented application gathers profile information and stores the profile information (block 808).

Next, the user or compiler invokes the compiler again to perform a second pass compilation. The compiler makes use of the profile information to guide optimizations (block 810). In a typical case, in the second pass compilation, the compiler may perform many more optimizations than in the first pass. In accordance with exemplary aspects of the present invention, one of the optimizations the compiler performs is region based code straightening (block 812). After all the optimizations are performed, the compiler may perform still more optimizations (block 814). Thereafter, the compiler generates machine executable application code (block 816) and operation ends.

With reference now to FIG. 9, operation of a region based code straightening mechanism is shown. Operation begins and the region based code straightening mechanism builds a control flow graph with profile information (block 902). Then, the region based code straightening mechanism performs a depth-first search (block 904) and generates a depth-first search list of basic blocks based on the profile information (block 906). Thereafter, the region based code straightening mechanism considers a next block (A) in the ordered list formed from performing a depth-first search of the control flow graph (block 908). When operation first begins, this next block (A) is the first block. Next, the code straightening mechanism determines whether block A is in the same immediate containing region (R) as the previously considered block (block 910).

If A is in the same immediate containing region, then the code straightening mechanism appends A to the final list (block 912). The code straightening mechanism determines whether block A is the end of the depth-first list (block 914). If A is the last block in the depth-first list, then operation ends. If, however, A is not the last block in the depth-first list in block 914, then operation transfers to block 908 to consider the next basic block in the depth-first list.

If A is not in region R in block 910, then the code straightening mechanism determines whether block A starts a new region and the new region is not contained in R (block 916). If A does not start a new region that is not contained in R, then operation proceeds to block 912 to append A to the final list. However, if A does start a new region that is not contained in R in block 916, then the code straightening mechanism determines whether there is any infrequently executed block (B) in R and B is not yet appended into the final list (block 918). If there is not any infrequently executed block (B) in R or there is a B in R, but B is already appended into the final list in block 918, then operation proceeds to block 912 to append A to the final list.

If there is any infrequently executed block (B) in R and B is not yet appended into final list, then the region based code straightening mechanism determines if: (1) all predecessors of B are appended to the final list and B is more frequently executed than A (block 920), or (2) all predecessors and successors of B are appended to the final list and B is executed at least once (block 922). If block B does not satisfy either of the above two conditions, then operation proceeds to block 912 to append A to final list.

If block B satisfies at least one of the two conditions at block 920 and block 922, the code straightening mechanism appends B to the final list before block A (block 924). Thereafter, operation returns to block 918 to determine whether any other infrequently executed block in R is not yet processed. Blocks 918-924 repeat until all infrequently executed blocks in R are processed.

Thus, the exemplary aspects of the present invention solve the disadvantages of the prior art by providing a region-based code straightening mechanism to line up frequently executed basic blocks together based on profile directed feedback. The region-based code straightening lines up the basic blocks in order of execution sequence, but does not move infrequently executed basic blocks too far away from its predecessors. As such, code locality is maintained, thus reducing instruction cache misses.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for code straightening, comprising the steps of:
creating a control flow graph for a procedure;
forming an ordered list of instruction blocks of the procedure; and
performing region based code straightening to move at least one instruction block closer to its predecessor, thereby generating a final list of instruction blocks.

2. The computer implemented method of claim 1, wherein the control flow graph includes profile information for the instruction blocks.

3. The computer implemented method of claim 2, further comprising:
generating instrumented code from the procedure; and
running the instrumented code with training data to generate the profile information.

4. The computer implemented method of claim 3, further comprising:
generating a new control flow graph for the procedure based on the final list of instruction blocks.

5. The computer implemented method of claim 1, wherein performing region based code straightening comprises:
appending a current instruction block to the final list of instruction blocks if the current instruction block is in the same immediate containing region as the previous block in the ordered list of instruction blocks.

6. The computer implemented method of claim 5, wherein performing region based code straightening further comprises:
if the current instruction block is not in the same immediate containing region as the previous block, determining whether the current instruction block starts a new region that is not in the immediate containing region;
if the current instruction block starts a new region that is not in the immediate containing region, identifying an infrequently executed instruction block in the immediate containing region; and
copying the infrequently executed instruction block to the final list of instruction blocks before the current instruction block.

7. The computer implemented method of claim 6, wherein identifying an infrequently executed instruction block in the immediate containing region comprises:
determining whether all predecessors of the infrequently executed instruction block are in the final list of instruction blocks and the infrequently executed instruction block is more frequently executed than the current instruction block.

8. The computer implemented method of claim 6, wherein identifying an infrequently executed instruction block in the immediate containing region comprises:
determining whether all predecessors and successors of the infrequently executed instruction block are in the final list of instruction blocks and the infrequently executed instruction block is executed at least once.

9. A computer system for region based code straightening, the computer system comprising:
a memory having stored therein a procedure;
a processor functionally connected to the memory; and
a compiler executing on the processor, wherein the compiler creates a control flow graph for the procedure,
wherein the compiler forms an ordered list of instruction blocks, and
wherein the compiler comprises a region based code straightening mechanism that moves at least one instruction block closer to its predecessor and generates a final list of instruction blocks.

10. The computer system of claim 9, wherein the region based code straightening mechanism appends a current instruction block in the ordered list of instruction blocks to the final list of instruction blocks if the current instruction block is in the same immediate containing region as the previous block in the ordered list of instruction blocks.

11. The computer system of claim 10, wherein the region based code straightening mechanism:
determines whether the current instruction block starts a new region that is not in the immediate containing region in the ordered list of instruction blocks if the current instruction block is not in the same immediate containing region as the previous block in the ordered list of instruction blocks,
identifies an infrequently executed instruction block that is in the immediate containing region in the ordered list of instruction blocks if the current instruction block starts a new region that is not in the immediate containing region in the ordered list of instruction blocks, and
copies the infrequently executed instruction block to the final list of instruction blocks before the current instruction block.

12. A computer program product for region based code straightening, the computer program product comprising:
a computer usable medium having computer usable program code comprising:
computer usable program code for creating a control flow graph for a procedure;
computer usable program code for forming an ordered list of instruction blocks; and
computer usable program code for performing region based code straightening to move at least one instruction block closer to its predecessor, wherein the region based code straightening generates a final list of instruction blocks.

13. The computer program product of claim 12, wherein the control flow graph includes profile information for the instruction blocks.

14. The computer program product of claim 13, further comprising:
computer usable program code for generating instrumented code from the procedure; and
computer usable program code for running the instrumented code with training data to generate the profile information.

15. The computer program product of claim 14, further comprising:
computer usable program code for generating a new control flow graph for the procedure based on the final list of instruction blocks.

16. The computer program product of claim 13, further comprising:
computer usable program code for compiling the procedure based on the final list of instruction blocks.

17. The computer program product of claim 13, wherein the computer usable program code for performing region based code straightening comprises:
computer usable program code for appending a current instruction block in the ordered list of instruction blocks to the final list of instruction blocks if the current instruction block is in the same immediate containing region as the previous block in the ordered list of instruction blocks.

18. The computer program product of claim 17, wherein the computer usable program code for performing region based code straightening further comprises:
computer usable program code for determining whether the current instruction block starts a new region that is not in the immediate containing region in the ordered list of instruction blocks if the current instruction block is not in the same immediate containing region as the previous block in the ordered list of instruction blocks;
computer usable program code for identifying an infrequently executed instruction block that is in the immediate containing region in the ordered list of instruction blocks if the current instruction block starts a new region that is not in the immediate containing region in the ordered list of instruction blocks; and
computer usable program code for copying the infrequently executed instruction block to the final list of instruction blocks before the current instruction block.

19. The computer program product of claim 18, wherein the computer usable program code for identifying an infrequently executed instruction block that is in the immediate containing region comprises:
computer usable program code for determining whether all predecessors of the infrequently executed instruction block are in the final list of instruction blocks and the infrequently executed instruction block is more frequently executed than the current instruction block.

20. The computer program product of claim 18, wherein the computer usable program code for identifying an infrequently executed instruction block that is in the immediate containing region comprises:
computer usable program code for determining whether all predecessors and successors of the infrequently executed instruction block are in the final list of instruction blocks and the infrequently executed instruction block is executed at least once.
